(19) United States
(12) Patent Application Publication
(10) Pub. No.: US 2008/0236067 A1
(43) Pub. Date: Oct. 2, 2008

(54) Glazing Component Connection and Method

(75) Inventor: Cliff Gordon, Armargh (GB)

Correspondence Address: HUSCH BLACKWELL SANDERS LLP, 720 OLIVE STREET, SUITE 2400, ST. LOUIS, MO, 63101, US

(73) Assignee: BURNDEN HOLDINGS (UK) LIMITED, Bolton (GB)

(21) Appl. No.: 10/597,340

(22) PCT Filed: Jan. 21, 2005
(86) PCT No.: PCT/GB05/00197

§ 371 Date: Jan. 15, 2008

(30) Foreign Application Priority Data
Jan. 22, 2004 (GB) 0401326.4

(51) Int. Cl. E06B 3/964

(52) U.S. Cl. 52/204.62; 52/741.1

(57) ABSTRACT

There is disclosed a glazing component connector (10) comprising a first part (12) and a second part (14), the first part (12) comprising a head (20) for reception by a complementary channel (16), from which head extends a shank (22) for enabling connection to another glazing component, and a locking clip (14) for locating about the head thereby to secure the first part (12) to the channel (16).

### FIELD OF THE INVENTION

The present invention relates to glazing component connectors, glazing components connected by such connectors, structures incorporating such components, methods of connection of glazing components and methods of constructing structures incorporating such components.

### BACKGROUND TO THE INVENTION

The present invention is particularly, though not exclusively, concerned with conservatory structures and their assembly.

In the construction of conservatory structures, a variety of connectors is required for various components within the structure. Such connections need to be quick, simple, robust and suitable for the wide variety of conservatory configurations provided in the modern market. Additionally, for the connection of a number of components, some angular flexibility is required. For instance, when a glazing bar is connected to a hip, the angle of their connection can vary between conservatory designs. Accordingly, a connector for connecting such components needs to provide the necessary amount of angular variation. Typically, the connection angle variation of up to about 40° is required.

Preferred embodiments of to the present invention aim to obviate or overcome a disadvantage of the prior art, whether such disadvantage or prior art is referred to herein or otherwise.

### SUMMARY OF THE INVENTION

According to the present invention in a first aspect, there is provided a glazing component connector comprising a first part and a second part, the first part comprising a head for reception by a complementary channel, from which head extends a shank for enabling connection to another glazing component, and a locking clip for locating about the head thereby to secure the first part to the channel.

Suitably, the locking clip is generally C-shaped. Suitably, the ends of the C-shaped clip comprise diverging feet.

Suitably, the locking clip comprises at least one hole therethrough. Suitably, the hole is suitable for receiving a grub screw for securing the first part in position. Suitably, the hole is opposite the open part of the C-shaped clip. Suitably, the clip comprises three holes therethrough. Suitably, the locking clip comprises a shaped part to receive the shank of the first part.

Suitably, the locking clip comprises a guide tab extending therefrom.

Suitably, the head comprises a truncated ball.

Suitably, the shank comprises an external thread

According to the present invention in a second aspect, there is provided a first glazing component comprising a channel, a glazing component connector according to the first aspect of the present invention, wherein the head s fits within the channel and the locking clip fits between the outside of the head and the inside of the channel, and a second a glazing component connected to the first glazing component by the first part of the glazing component connector.

Suitably, the channel is a longitudinal channel.

Effectively, the locking clip increases the diameter of the head whereby the head can no longer be removed from the channel through the longitudinal opening therein formed by the channel. Thus, the head of the first part can be inserted into the channel through the longitudinal opening therein and the locking clip can be slid over the head axially.

Suitably, the channel is generally C-shaped.

Suitably, the first glazing component comprises a component selected from one of an eaves beam, a hip rafter, wall plate and a valley.

Suitably, the angle of the first glazing component relative to the second glazing component can be varied by pivotal movement of the connector.

According to the present invention in a third aspect, there is provided a structure comprising a first glazing component connected to a second glazing component in a manner according to the second aspect of the present invention.

Suitably, the structure comprises a conservatory s structure.

According to the present invention in a fourth aspect, there is provided a method of connection of a first glazing component to a second a glazing component, the first glazing component comprising a channel, the method comprising the steps of providing a glazing component connector according to the first aspect of the present invention, inserting one of the first part and the second part into the channel of the first glazing component, inserting the other of the first part and the second part into the channel of the first glazing component and connecting the second the glazing component to the first glazing component using the shank of the first part.

Suitably, the first part is inserted into the channel before the second part. Suitably, the channel comprises a longitudinal opening therein, and the first part is inserted into the longitudinal opening of the channel. Suitably, the locking clip is moved axially over the first part.

Alternatively, the channel comprises a longitudinal opening therein, and the locking clip is inserted into the longitudinal opening of the channel. Suitably, the first part is inserted axially into the channel inside the glazing clip.

According to the present invention in a fifth aspect, there is provided a method of constructing a structure, which method comprises connecting a first glazing component to a second glazing component according to the fourth aspect of the present invention.

Suitably, the structure is a conservatory structure.

### BRIEF DESCRIPTION OF THE DRAWINGS

The present invention will now be described, by way of example only, with reference to the drawings that follow; in which:

FIG. 1 is an end elevation of a glazing component connector according to the present invention in a first glazing component.

FIG. 2 is an exploded view of FIG. 1.

FIG. 3 is an end elevation showing the first part of the glazing component connector being inserted into the first glazing component.

FIG. 4 is an end elevation showing the second part of the glazing component connector being inserted into the first glazing component.

FIG. 5 is a functional flow diagram of a method according to the present invention.

FIG. 6 is a plan of the view of a first embodiment of a glazing component connector second part.

FIG. 7 is a cross-sectional end view of the part shown in FIG. 6.

FIG. 8 is a plan view of a second embodiment of a glazing component connector second part.

FIG. 9 is a plan view of a third embodiment of a glazing component connector second part.

FIG. 10 is a schematic perspective elevation of a conservatory structure incorporating glazing components connected according to the present invention.

FIG. 11 is an enlarged cross-sectional end view of the glazing component connector of FIG. 1 showing the range of angles it can adopt.

### DESCRIPTION OF THE PREFERRED EMBODIMENTS

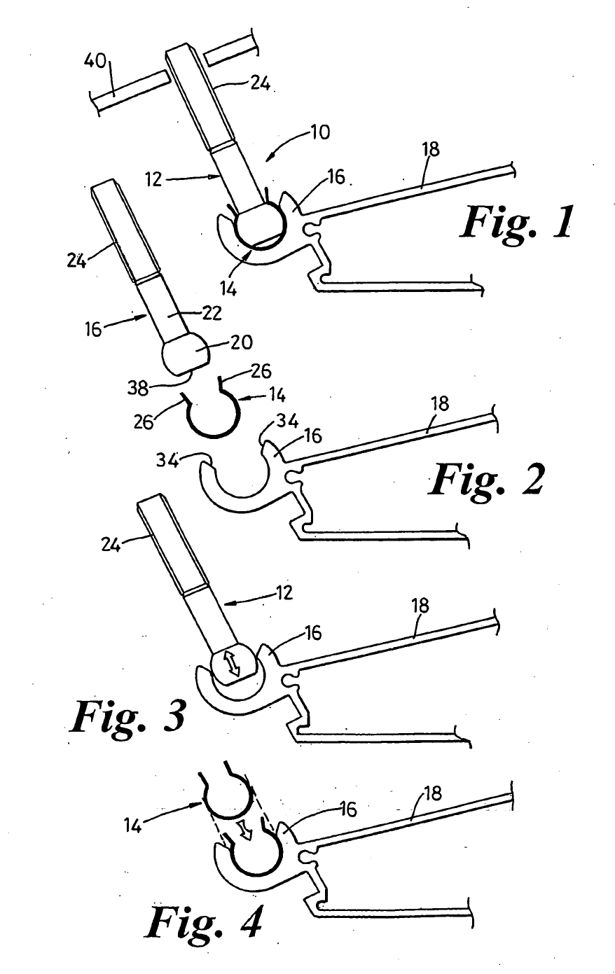

Referring to FIG. 1 of the drawings that follow, there is shown a glazing component connector 10 comprising a first part 12 and a second part 14, which glazing component connector 10 is located in a C-shaped channel 16 of a first glazing component 18, in this case an eaves beam.

Referring additionally to FIG. 2 of the drawings that follow, the first part 12 comprises a head 20 and a shank 22. The head 20 consists of a truncated sphere, and from which extends the shank 22 which has a threaded portion 24. First part 12 is formed from a steel casting or the like.

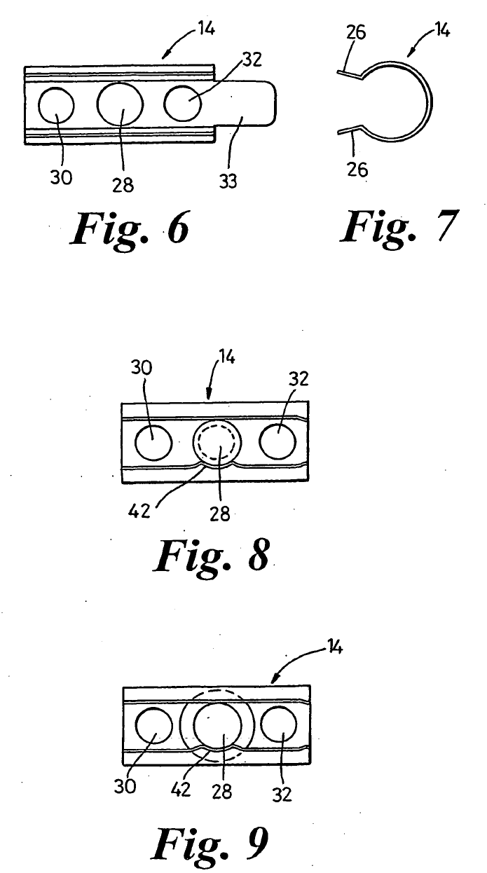

Second part 14 is a locking clip which comprises an elongate member, generally C-shaped in cross section, from the open part of which C-shape extend two diverging feet 26. Approximately centrally located in the C-shaped part of the locking clip 14 are three holes 28, 30, 32 (see FIGS. 6-10). A tab 33 is provided at one end of the locking clip 14. The locking clip 14 is pressed from sprung steel.

First glazing component 18 can be a generally standard component except that it provides the C-shaped channel 16 extending from end-to-end for approximately 270°. Channel 16 has open ends 34. First glazing component 18 is a plastics extrusion. Channel 16 extends longitudinally along the length of first glazing component of 18 and the open ends 34 form a longitudinal opening in the C-shaped channel 16.

As can be seen from FIGS. 3 and 4 of the drawings that follow, the head 20 of first part 12 can pass into channel 16 of the first glazing component 18 through the open ends 34 of channel 16. Similarly, locking clip 14 can also pass into channel 16 of the first glazing component 18 through the open ends 34 of channel 16. In the case of locking clip 14, its normal diameter is greater than the spacing between the open ends 34, but it can be squeezed by using feet 26 to fit in channel 16.

In this embodiment, the external diameter of head 20 is approximately 0.5 mm smaller than the internal diameter of the C-shaped channel 16 and the glazing clip thickness is just less than 0.5 mm.

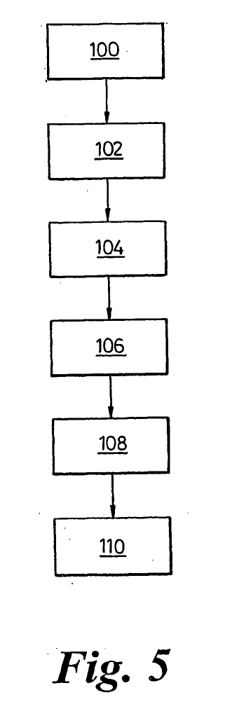

Referring to FIG. 5 of the drawings that follow, a method of use of the glazing component connector 10 will now be described.

In step 100 the first glazing component 18 having a C-shaped channel 16 is provided. In step 102 a glazing component connector 10 is provided. In step 104 head 20 of first part 12 is inserted into C-shaped channel 16 through the longitudinal opening therein. Tab 33 can aid the insertion of the head 20, acting as a guide. In step 106 the locking clip 14 is slid axially into the gap between the outside of head 20 and the inside of the C-shaped channel 16. In practice the position desired for the glazing component connector 10 may be spaced significantly from either end of the glazing component 18, in which case (or otherwise) both the first and second parts 12, 14 can be inserted into the longitudinal gap of C-shaped channel 16, and then the glazing clip 14 can be slid axially (relative to the longitudinal axis of the C-shaped channel 16) over the head 20 of first part 12.

In an alternative step 106, instead the locking clip 14 can be inserted into C-shaped channel 16 first and then the head 20 of first past 12 can be slid axially into glazing clip 14.

In step.108, the shank 22 of first part 12 is located at the desired angle and a grub screw 36 (FIG. 11) is inserted through the base of C-shaped channel 16 to engage with a flat 38 (FIG. 2) of head 20. FIG. 11 of the drawings that follow illustrates the range of angles the first part 12 can adopt in the C-shaped channel 16, over a range of 41°. Thus, the angle of the first glazing component relative to the second glazing component can be varied by pivotal movement of the connector. The centre of rotation of the pivoting action is within head 20.

In step 110 a second glazing component 40, such as in this case a hip rafter, is connected to first glazing component 18 using the shank 22 of first part 12 typically this will involve passing the shank to 22 into a hole in the second glazing component 40 and using a nut (not shown) to secure the second glazing component 40 in place. Alternatively, first part 12 is bolted to second glazing component 40 before being connected to first glazing component. Instead of a nut, the shank can tap into a port.

FIGS. 6-9 show various embodiments of locking clip 14. In the embodiment of FIGS. 8 and 9, the glazing clip 14 does not include the diverging feet 26. However the edge of the C-shaped includes a shaped portion 42 for receiving a part of the shank 22, helping to locate the shank 22 in place and stop it from moving unhelpfully when the second glazing component 40 is being located.

Referring to FIG. 9 of the drawings that follow, there is shown a third embodiment of a glazing clip 14, the end view of which is similar to FIG. 9.

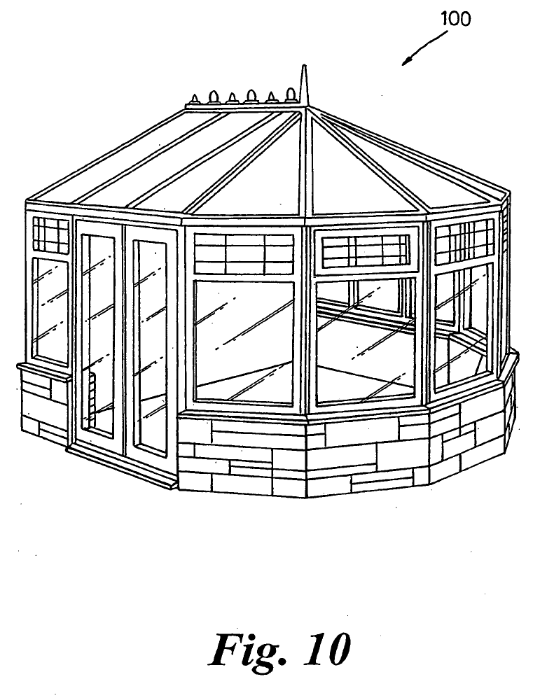

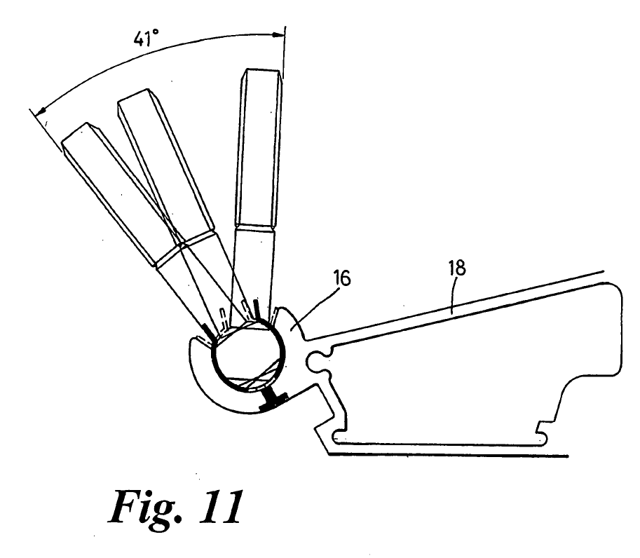

Referring to FIG. 10 of the drawings that follow, there is shown a conservatory structure 100 comprising a plurality of glazing components connected using the glazing component connector described herein.

Thus, preferred embodiments of the present invention provide a glazing component connector that is simple to use, reliable and robust yet flexible in its applications.

Although described hearing a relation to the connection of an eaves beam to another glazing component, the glazing component connector 10 is not limited to eaves beams and can be used for, for instance, hips, valleys and wall plates.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment (s). The invention extends to any novel one, or any novel combination, of the features disclosed in this specification (including any accompanying claims, abstract and drawings), or to any novel one, or any novel combination, of the steps of any method or process so disclosed.

1. A glazing component connector comprising a first part and a second part, the first part comprising a head for reception by a complementary channel, from which head extends a shank for enabling connection to another glazing component, and a locking clip for locating about the head thereby to secure the first part to the channel.

2. A glazing component connector according to claim 1, in which the locking clip is generally C-shaped.

3. A glazing component connector according to claim 2, in which the ends of the C-shaped clip comprise diverging feet.

4. A glazing component connector according to claim 1, in which the locking clip comprises at least one hole therethrough.

5. A glazing component connector according to claim 4, in which the hole is suitable for receiving a grub screw for securing the first part in position.

6. A glazing component connector according to claim 4, in which the hole is opposite the open part of the C-shaped clip.

7. A glazing component connector according to claim 4, in which the clip comprises three holes therethrough.

8. A glazing component connector according to claim 1 in which the locking clip comprises a shaped part to receive the shank of the first part.

9. A glazing component connector according to claim 1, in which the locking clip comprises a guide tab extending therefrom.

10. A glazing component connector according to claim 1, in which the head comprises a truncated ball.

11. A glazing component connector according to claim 1, in which the shank comprises an external thread.

12. A first glazing component comprising a channel, a glazing component connector according to claim 1, wherein the head fits within the channel and the locking clip fits between the outside of the head and the inside of the channel, and a second a glazing component connected to the first glazing component by the first part of the glazing component connector.

13. A first glazing component according to claim 12, in which the channel is a longitudinal channel.

14. A first glazing component according to claim 12, in which the channel is generally C-shaped.

15. A first glazing component according to claim 12, in which the first glazing component comprises a component selected from one of an eaves beam, a hip rafter, wall plate and a valley.

16. A first glazing component according to claim 12, in which the angle of the first glazing component relative to the second glazing component can be varied by pivotal movement of the connector.

17. A structure comprising a first glazing component connected to a second glazing component in a manner according to claim 12.

18. A structure according to claim 17, in which the structure comprises a conservatory structure.

19. A method of connection of a first glazing component to a second a glazing component, the first glazing component comprising a channel, the method comprising the steps of providing a glazing component connector according to claim 1, inserting one of the first part and the second part into the channel of the first glazing component, inserting the other of the first part and the second part into the channel of the first glazing component and connecting the second the glazing component to the first glazing component using the shank of the first part.

20. A method of connection according to claim 19, in which the first part is inserted into the channel before the second part.

21. A method of connection according to claim 19, in which the channel comprises a longitudinal opening therein, and the first part is inserted into the longitudinal opening of the channel.

22. A method of connection according to claim 19, in which the locking clip is moved axially over the first part.

23. A method of connection according to claim 19, in which the channel comprises a longitudinal opening therein, and the locking clip is inserted into the longitudinal opening of the channel.

24. A method of connection according to claim 23, in which the first part is inserted axially into the channel inside the glazing clip.

25. A method of constructing a structure, which method comprises connecting a first glazing component to a second glazing component according to claim 19.

26. A method of constructing a structure according to claim 25, in which the structure is a conservatory structure.
